(19) United States
(12) Patent Application Publication
(10) Pub. No.: US 2019/0064595 A1
(43) Pub. Date: Feb. 28, 2019

(54) DISPLAY SYSTEM

(71) Applicant: Radiant Choice Limited, The Valley (AI)

(72) Inventors: Nguyen The Tran, Anaheim, CA (US); Jiun-Pyng You, Irvine, CA (US)

(21) Appl. No.: 15/876,493

(22) Filed: Jan. 22, 2018

Related U.S. Application Data
(60) Provisional application No. 62/550,702, filed on Aug. 28, 2017.

(51) Int. Cl. G02F 1/1335; C09K 19/02; C09K 19/04

(52) U.S. Cl. CPC G02F 1/133609; G02F 1/133603; G09G 2320/0242; C09K 19/04; C09K 19/02

(57) ABSTRACT

Aspects of the invention include a multi-functional optical unit, panel lighting systems and display systems having the multi-functional optical unit. The multi-functional optical unit formed in a single-layered or multi-layered structure includes primary fillers and assisted fillers. The primary fillers include wavelength conversion materials adapted to function as at least one of mixing light, converting light, and trapping/guiding primary light. The assisted fillers are hybrids of fillers of sizes, shapes, and porosities having elongated shapes, fumed structures, or aspherical shapes for improving light trapping and propagating in an x-y plane direction of the multi-functional optical unit and light scattering/mixing. The multi-functional optical unit has a plurality of microstructures with a cross-section of a triangle, trapezium, trapezoid, square, curved, or rectangular shape to improve angular color uniformity, formed on one of its top and bottom surfaces.

### CROSS-REFERENCE TO RELATED PATENT APPLICATION

This application claims priority to and the benefit of, pursuant to 35 U.S.C. § 119(e), U.S. provisional patent application Ser. No. 62/550,702, filed Aug. 28, 2017, which is incorporated herein by reference in its entirety.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference is individually incorporated by reference.

### FIELD

The present disclosure relates generally to liquid crystal displays, and more particularly to a backlighting unit for a liquid crystal display panel and a multi-functional quantum-optics member that enables reduction of components of the backlighting unit.

### BACKGROUND

The background description provided herein is for the purpose of generally presenting the context of the present disclosure. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present disclosure.

Almost all liquid crystal displays (LCDs) now employ light-emitting diode (LED) based backlighting, which enables a thinner profile of an LCD as well as better quality and enhanced energy efficiency. There is attempting to minimize the number of light emitting sources of a backlight module in order to reduce costs. However, it affects quality of the backlight module including intensity and color uniformity.

A wavelength conversion layer that is separated from an LED light source was introduced for edge-lit backlighting shown in U.S. Pub. No. 2001/0001207 and direct-lit LCD backlight shown in U.S. Pat. No. 7,052,152. The wavelength conversion layer separated from an LED light source can have a better efficiency and uniformity. However, these approaches can be more expensive than a white LED light source approach because large amounts of wavelength conversion and binding/matrix materials are required. Both U.S. Pat. No. 7,052,152 and U.S. Pub. No. 2001/0001207 do not provide a solution for this issue. Moreover, both of proposed systems still need other films, including diffusing films (DFs), brightness enhancement films (BEFs), and/or dual brightness enhancement film (DBEF), to improve the uniformity and brightness of the backlight system. The use of those films not only increase a material cost of the backlighting unit but also an assembly cost of the entire unit. Therefore, it is necessary to reduce both material and component costs by reducing the amount of materials used and the number of components. Moreover, the use of additional performance enhancement films result in light output with a CIE xy color space different than a desired or designed CIE xy color space.

Therefore, a heretofore unaddressed need exists in the art to address the aforementioned deficiencies and inadequacies.

### SUMMARY

In one aspect, the invention relates to a multi-functional optical unit. In one embodiment, the multi-functional optical unit includes primary fillers. The primary fillers comprise wavelength conversion materials adapted to function as at least one of mixing light, converting light, and trapping/guiding primary light, where the wavelength conversion materials comprise at least one of phosphor materials, quantum dot materials, and/or dye materials that operably and at least partially absorb primary light and/or other appropriate activating light and then emit light of different wavelengths.

The multi-functional optical unit also includes assisted fillers. The assisted fillers comprise porous particles and/or non-porous particles that are at least one of metal oxides including titanium dioxide (TiO₂), aluminum oxide (Al₂O₃), zinc oxide (ZnO), and the likes, boron oxide (BN), glass, polymers, sapphire, silicon dioxide (SiO₂), polycarbonate, and liquid crystal materials.

The multi-functional optical unit further includes a matrix comprising one of glass, polymers, polymethyl methacrylate (PMMA), polystyrene, polycarbonate, silicone, ceramic composite, thiol-alkene resin, or any optical transparent materials that contain the wavelength conversion materials to form a wavelength conversion layer.

In one embodiment, the wavelength conversion materials comprise at least one of green, yellow, green-yellow, orange, and red phosphor particles or quantum dots or dyes that at least partially absorb the primary light of blue, violet, or deep blue from light sources or other appropriate activating light and emit wavelengths of light that are perceived as green, yellow, green-yellow, orange, and red, respectively, by human eyes.

In one embodiment, the phosphor materials comprise phosphor particles adapted with a mean free path length per a fixed particle volume amount/percentage in a range around a lowest mean free path length value so that a maximum trapping level is achieved, where the particles have dimensions in a range of about 0.01 μm to 10 μm.

In one embodiment, the wavelength conversion materials are distributed uniformly over the single-layered structure, or form a gradient concentration distribution over the single-layered structure.

In one embodiment, the assisted fillers are hybrids of fillers of sizes, shapes, and porosities.

In one embodiment, the assisted fillers comprise particles with fumed structures, aspherical shapes, and/or elongated shapes such as rods, ellipsoids, tubes, nanorods, nanofibers, nanowires, nanotubes, combinations thereof.

In one embodiment, the elongated particles have an aspect ratio in a range of about 1.01 to 1000 and a shorter size in a range of about 4 nm to 4 μm.

In one embodiment, the elongated particles are arranged randomly, or arranged with its long dimension forming a small angle arranged with the x-y plane, or with its short dimension forming a small angle with the x-y plane.

In one embodiment, the assisted fillers comprise a liquid crystal material operably functioning as light mixing agents, where the liquid crystal material is embedded in a matrix containing the wavelength conversion materials.

In one embodiment, the assisted fillers comprise spherical particles adapted with a mean free path length per a fixed particle volume amount/percentage in a range around a lowest mean free path length value so that a maximum trapping level is achieved, where the particles have dimensions in a range of about 0.01 μm to 10 μm.

In one embodiment, the primary fillers and the assisted fillers are mixed in the matrix to form a single-layered structure.

In one embodiment, an absolute refractive index difference |Δnₜ| between the matrix and the primary fillers or assisted fillers is in the range of about 0.01 to 2.

In one embodiment, one of a top surface and a bottom surface of the multi-functional optical unit comprises a plurality of microstructures being at least one of cones, prisms, pyramids, hemispheres, curved pumps, truncated cones, truncated pyramids, grooves, protrusions, facets, surface or volume holograms, gratings, or combinations thereof, to improve angular color uniformity. In one embodiment, the plurality of microstructures has a size in a range of about 0.1 μm to about 3 mm, and a density in a range of about 1000000/mm² to 1/mm².

In one embodiment, the wavelength conversion layer is completely embedded by outer layers including top, bottom and side layers to prevent moisture to penetrate to the wavelength conversion materials.

In one embodiment, the multi-functional optical unit further comprises a cladding layer formed on one of a top surface and a bottom surface of the wavelength conversion layer, where the cladding layer comprises one of glass, polymers, polymethyl methacrylate (PMMA), polystyrene, polycarbonate, silicone, ceramic composite, or any optical transparent materials, where a reflective index of the cladding layer is different from that of the wavelength conversion layer.

In one embodiment, the cladding layer is a transparent layer without fillers.

In one embodiment, the cladding layer is formed on the bottom surface of the wavelength conversion layer, where a top surface of the cladding layer that interfaces with the bottom surface of the wavelength conversion layer comprises at least one of micro structures including cones, pyramids, hemispheres, curved pumps, truncated cones, truncated pyramids, and grooves to direct more primary light toward the horizontal direction so that the primary light is out of an extraction zone as the light is incident on the top surface of the wavelength conversion layer or on a bottom surface of the cladding layer and reflects back into the wavelength conversion layer.

In one embodiment, the cladding layer comprises assisted fillers to assist guiding the primary light toward x-y-plane direction through scattering.

In one embodiment, the interface between the wavelength conversion layer and the cladding layer is a smooth surface.

In one embodiment, the multi-functional optical unit further comprises another cladding layer formed on the other of a top surface and a bottom surface of the wavelength conversion layer. In one embodiment, the another cladding layer is a transparent layer with or without the assisted fillers.

In one embodiment, the multi-functional optical unit has a liquid crystal layer residing between the wavelength conversion layer and the top cladding layer, the liquid crystal layer containing liquid crystal material that is arranged in a twisted nematic phase.

In another aspect of the invention, a panel lighting system comprises the multi-functional optical unit as disclosed above.

In yet another aspect of the invention, a display system comprises the multi-functional optical unit as disclosed above.

In one embodiment, the display system further comprises a housing being an open shell having a bottom and side walls; at least one printed circuit board (PCB) placed on the bottom of the housing; at least one light source placed on the at least one PCB, where at least one light source is adapted to emit primary light; a reflective sheet covering the at least one PCB and the inner side surface of the housing, where the reflective sheet has holes defined corresponding to locations of the at least one light source to expose the at least one light source; and a liquid crystal display (LCD) panel positioned above the multi-functional optical unit. In one embodiment, the multi-functional optical unit is separated from the at least one light source by an air gap, where the multi-functional optical unit comprises a single-layered structure or multi-layered structure.

In one embodiment, the at least one light source comprises light emitting diode (LED) emitters, laser diode (LD) emitters, quantum dot LED (DOLED) emitters, or organic LED (OLED) emitters.

In one embodiment, the display system further comprises a housing being an open shell having a bottom and side walls; at least one printed circuit board (PCB) placed on the side walls of the housing; at least one light source placed on the at least one PCB, wherein at least one light source is adapted to emit primary light; a reflective sheet covering the bottom surface of the housing; a light guide plate positioned between the reflective sheet and the multi-function optical unit; and a liquid crystal display (LCD) panel positioned above the multi-functional optical unit. The multi-functional optical unit comprises a single-layered structure or multi-layered structure.

These and other aspects of the invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1 is a schematic cross-sectional view of an LCD system according to one embodiment of the invention.

FIG. 2 is a schematic cross-section view of a multi-functional optical unit according to one embodiment of the invention.

FIG. 3 is a schematic portion of the cross-sectional view of a multi-functional optical unit according to one embodiment of the invention.

FIG. 4 is a schematic portion of a cross-sectional view of a multi-functional optical unit with structures or micro structures at the interface between a wavelength conversion layer and a bottom cladding layer according to one embodiment of the invention.

FIG. 5 is a schematic cross-section view of the multi-functional optical unit according to one embodiment of the invention.

FIG. 6 is a schematic cross-sectional view of an edge-lit LCD system according to one embodiment of the invention.

### DETAILED DESCRIPTION

The disclosure will now be described more fully hereinafter with reference to the accompanying drawings, in which exemplary embodiments of the disclosure are shown. This invention may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the disclosure or of any exemplified term. Likewise, the disclosure is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the disclosure.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the disclosure.

Typically, terms such as “about,” “approximately,” “generally,” “substantially,” and the like unless otherwise indicated mean within 20 percent, preferably within 10 percent, preferably within 5 percent, and even more preferably within 3 percent of a given value or range. Numerical quantities given herein are approximate, meaning that the term “about,” “approximately,” “generally,” or “substantially” can be inferred if not expressly stated.

Embodiments of the invention are illustrated in detail hereinafter with reference to accompanying drawings. It should be understood that specific embodiments described herein are merely intended to explain the invention, but not intended to limit the invention. In accordance with the purposes of this invention, as embodied and broadly described herein, this invention, in certain aspects, relates to a multi-functional optical unit, panel lighting systems and display systems having the multi-functional optical unit.

According to the invention, a performance-enhancement-film-free backlighting unit for an LCD provides a high efficiency, better color uniformity at a low cost with a multi-functional optical unit. The LCD backlighting unit comprises a housing being an open shell with a bottom and side walls, a PCB on which at least one light source such as LED device is bonded, a reflective sheet having holes corresponding to each light source location to expose light source and residing on top of the PCB, and a multi-functional optical unit separated from the light source by an air gap.

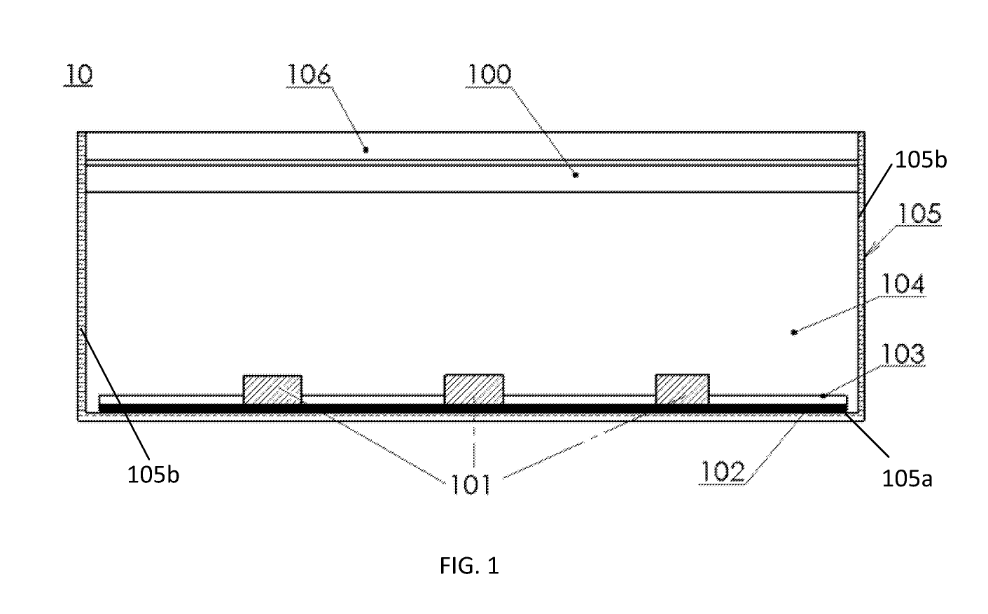

Referring to FIG. 1, a schematic of the LCD system is shown according to one embodiment of the invention. The LCD system 10 comprises a housing 105 being an open shell with a bottom 105a and side walls 105b, a printed circuit board (PCB) 102 placed on the bottom 105a of the housing 105, at least one light source 101 such as LED devices placed on the PCB 102, a reflective sheet 103 having holes defined corresponding to locations of the light source 101 and placed on the PCB 102 such that the light source 101 is exposed to the holes of the reflective sheet 103, and a multi-functional optical unit 100 separated from the light source 101 by an air gap 104, and positioned below an LCD panel 106 and required components for the LCD panel 106. The LCD system 10 that is devoid of performance-enhancing components such as DF, BEF, and DBEF components reduces not only the component cost but also the assembly cost.

In certain embodiments, the reflective sheet 103 covers the inner surface of the bottom 105a of the housing 105 or the inner surfaces of both the bottom 105a and the side walls 105b of the housing 105. In certain embodiments, the inner surfaces of the housing 105 can be coated with materials having high light reflectivity. In certain embodiments, the light source 101 can be LED emitters or laser diode (LD) emitters or DQLED emitters or OLED emitters. In various embodiments, the reflective sheet 103 can be of diffusive reflection to provide addition light mixing function to the backlighting unit 10. In various embodiments, the reflective sheet 103 can be of specular reflection or mixing of specular and diffusive reflection to provide a light spreading function so that a larger illumination area can be covered with the light source.

In certain embodiments, the multi-functional optical unit 100 is constructed to integrate several functions into the multi-functional optical unit 100 such as a function of a diffusing film, a function of lengthening an optical path-length of wavelength-conversion-material activating light (also called as primary light) to increase interaction between the primary light and the wavelength conversion materials, a light mixing function, and a light emission enhancing function. By integrating these functions into the multi-functional optical unit 100, the material cost and the assembly cost of the LCD system 10 are greatly reduced, while the efficiency of the LCD system 10 is significantly improved. According to the invention, the multi-functional optical unit 100 eliminates the use of a diffusing film, thereby reducing materials being used to reduce the overall cost of the LCD system 10. With the enhanced probability of the absorption of the primary light by a unit volume of the wavelength conversion materials as well as the reduction in the amount of other materials, the multi-functional optical unit 100 can also be able to be formed as a very thin film to reduce the material cost.

Currently, the wavelength conversion materials cost is a large portion of the total material cost of the multi-functional optical unit 100. The amount of the wavelength conversion materials used in the multi-functional optical unit 100 depend on the structure/architecture of the multi-functional optical unit 100, and the materials being used including intrinsic and physical properties of the wavelength conversion materials, fillers, and binder/matrix, such as a refractive index, size, shape, index mismatch between materials, and absorption ability of the primary light by the wavelength conversion materials per amount unit (such as volume or weight). In certain embodiments, the absorption ability of the primary light by the wavelength conversion materials are improved by increasing trapping ability of the primary light in the multi-functional optical unit 100, especially in a region containing the wavelength conversion materials.

In certain embodiments, increasing trapping of the primary light increases an effective optical path length of the primary light and thus increases interaction between the wavelength conversion materials and the primary light as well as absorption of the primary light by the wavelength conversion materials, thereby reducing the amount of the wavelength conversion materials being used.

In certain embodiments, increasing interaction between the wavelength conversion materials and the primary light in the backlight configuration can be performed in two ways: the first method is to confine light to the air space between the multi-functional optical unit 100 and the housing 105; and the second method is to confine light inside the multi-functional optical unit 100, especially inside a region containing the wavelength conversion materials. The first method causes a lot of light efficiency loss due to light absorption by surfaces or other components such as the reflective sheet 103, the housing 105, the PCB 102, and the package of the light source 101. The second method requires guiding the primary light toward a horizontal or x-y plane direction so that the optical path length of the primary light can be improved. As the primary light is guided toward the x-y-plane direction, the primary light can propagate longer inside the multi-functional optical unit 100, especially in a layer containing the wavelength conversion materials, before it is transmitted out from the multi-functional optical unit 100.

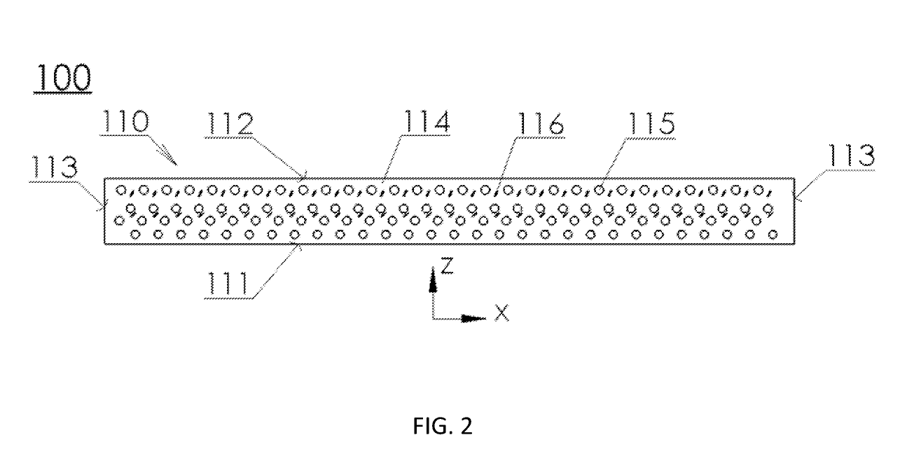

In certain embodiments, the multi-functional optical unit 100 comprises of a matrix 114, primary fillers 115, and assisted/additive fillers 116 that are mixed with the matrix 114 to form a the multi-functional optical unit 100, as shown in FIG. 2 that is a schematic cross-section view of the multi-functional optical unit 100, which is cut by a plane along a vertical direction (hereinafter “a vertical axis z”) that is perpendicular to a x-y plane. In certain embodiments, the primary fillers 115 include wavelength conversion materials such as phosphor materials that can be selected to function as at least one of primary light trapping-guiding and light mixing, and light conversion. According to the invention, improving interaction between the wavelength conversion materials and the primary light or the optical path length of the primary light inside the multi-functional optical unit 100 can be achieved by improving the primary light trapping function of the wavelength conversion materials and the x-y direction distributing/guiding of the primary light by the wavelength conversion materials. By enhancing and adding the trapping-guiding function to the wavelength conversion materials, the absorption of the primary light by the wavelength conversion materials can increase and the amount of the wavelength conversion materials can reduce. In certain embodiments, the wavelength conversion materials include spherical or aspherical particulates or particles that can be adapted to provide a mean free path length of the primary light per a fixed particle volume amount/percentage in a range around a lowest mean free path length value. In certain embodiments, the wavelength conversion particulates/particles have sizes in a range of about 0.01 μm to 10 μm. The wavelength conversion materials with the enhanced probability of the absorption of the primary light can reduce light absorption loss by other components of the LCD system and thus improve the efficiency of the LCD system.

In certain embodiments, the assisted fillers 116 include particles with elongated shapes, fumed structures, or aspherical shapes for improving light trapping and propagating in the x-y plane direction of the multi-functional optical unit 100 as well as light scattering/mixing. In certain embodiments, the elongated particles include rods, ellipsoids, tubes, nanorods, nanofibers, nanowires, nanotubes, combinations thereof, or the likes. In certain embodiments, the elongated particles are adapted to provide highly scattering phenomena like spherical fillers while it reflects more upwardly propagating primary light toward the x-y plane direction so as to improve optical path length of the primary light and to increase the probability of interaction between the primary light and the wavelength conversion materials. In certain embodiments, the elongated particles are also adapted to enable more uniform distribution of the wavelength conversion materials. In certain embodiments, the elongated particles can have an aspect ratio in a range of about 1.01 to 1000 and a shorter size in a range of about 4 nm to 4 μm. In certain embodiments, the elongated particles are arranged randomly. In certain embodiments, the elongated particles are arranged with its long dimension forming a small angle with the x-y plane. In certain embodiments, the elongated particles are arranged with its short dimension forming a small angle with the x-y plane.

In certain embodiments, the assisted fillers 116 include a liquid crystal material. In certain embodiments, the liquid crystal material is embedded in a matrix containing the wavelength conversion materials. With the elongated structure of the liquid crystal material, the liquid crystal material operably functions as light mixing agents.

In certain embodiments, the assisted fillers 116 include porous particles with at least one of spherical shapes, aspherical shapes, and elongated shapes, which include, but are not limited to, rods, ellipsoids tubes, nanorods, nanofibers, nanowires, and nanotubes. In certain embodiments, the size of the porous particles with the spherical shapes is in a range of about 5 nm to 10 μm. Preferably, it is about 0.1 μm to 1 μm. In certain embodiments, the porous particles with the elongated shapes can have an aspect ratio in a range of about 1.01 to 1000 and a shorter size in a range of about 4 nm to 4 μm. In certain embodiments, the elongated particles are arranged randomly. In certain embodiments, the porous elongated particles are arranged with its long dimension forming a small angle with the x-y plane.

In certain embodiments, the assisted fillers 116 include spherical particles that can be adapted with a mean free path length per a fixed particle volume amount/percentage in a range around a lowest mean free path length value so that a maximum trapping level can be achieved. In certain embodiments, the particles have dimensions in a range of about 0.01 μm to 10 μm. In certain embodiments, the particles have dimensions in a range of about 0.08 μm to 10 μm.

According to the invention, it is required that there is refractive index mismatches between the matrix and the fillers to create bending and distributing of the primary light to different directions. In certain embodiments, the absolute refractive index difference |Δnₜ| between the matrix and the fillers is in the range of about 0.01 to 2.

In certain embodiments, the matrix material includes glass, polymers, polymethyl methacrylate (PMMA), polycarbonate, silicone, ceramic composite, thiol-alkene resin, or any optical transparent materials.

In certain embodiments, the assisted fillers 116 include at least one of metal oxides such as, but are not limited to, titanium dioxide (TiO₂), aluminum oxide (Al₂O₃), zinc oxide (ZnO), and etc., boron oxide (BN), glass, polymers, sapphire, silicon dioxide (SiO₂), polycarbonate, and liquid crystal materials.

In certain embodiments, the wavelength conversion materials can be phosphor particles or quantum dot materials.

In certain embodiments, the wavelength conversion materials operably and at least partially absorb the primary light and then emit light of different wavelengths. In certain embodiments, the wavelength conversion materials operably converts the primary light, such as blue, violet, deep blue, to second and third light that is perceived as green and red, respectively, by human eyes. The wavelength conversion materials can be any materials that convert one wavelength of energy to another wavelength of energy such as, but are not limited to, phosphors, quantum dots, dyes, etc.

In certain embodiments, the wavelength conversion materials include at least one of green, yellow, green-yellow, orange, and red phosphor particles that at least partially absorb the primary light such as blue from the light sources and emit wavelengths of light that are perceived as green, yellow, green-yellow, orange, and red, respectively, by human eyes.

In certain embodiments, the wavelength conversion materials include at least one of green, yellow, green-yellow, orange, and red quantum dot or dye materials that at least partially absorb the primary light such as blue from light sources and emit wavelengths of light that are perceived as green, yellow, green-yellow, orange, and red by human eyes.

In certain embodiments, the green, yellow, green-yellow, orange, and red phosphor particles or quantum dots emit corresponding color light with at least one peak in each corresponding spectral power distribution.

In certain embodiments, the wavelength conversion materials are distributed uniformly over a layer containing the wavelength conversion materials.

In certain embodiments, the wavelength conversion materials form a gradient concentration distribution over a layer containing the wavelength conversion materials.

In certain embodiments, the light source 101 emits at least one primary light of spectrum that can activate the wavelength conversion materials. In certain embodiments, the light source 101 emits blue or violet light.

In certain embodiments, the light source 101 comprises a blue chip emitting the primary light of blue color and red wavelength conversion materials emitting red light. It means the light source provides the primary wavelength of light and the red light.

In certain embodiments, the light source 101 comprises a blue chip emitting the primary light of blue color and green wavelength conversion materials emitting green light. It means the light source provides blue light and green light.

In certain embodiments, the top surface of the multi-functional optical unit 100 comprises a plurality of micro structures such as cones, prisms, pyramids, hemispheres, curved pumps, truncated cones, truncated pyramids, and grooves with a cross-section of a triangle, trapezium, trapezoid, square, or rectangular to improve angular color uniformity. In certain embodiments, the plurality of microstructures also includes grooves, protrusions, facets, surface or volume holograms, gratings, and so on.

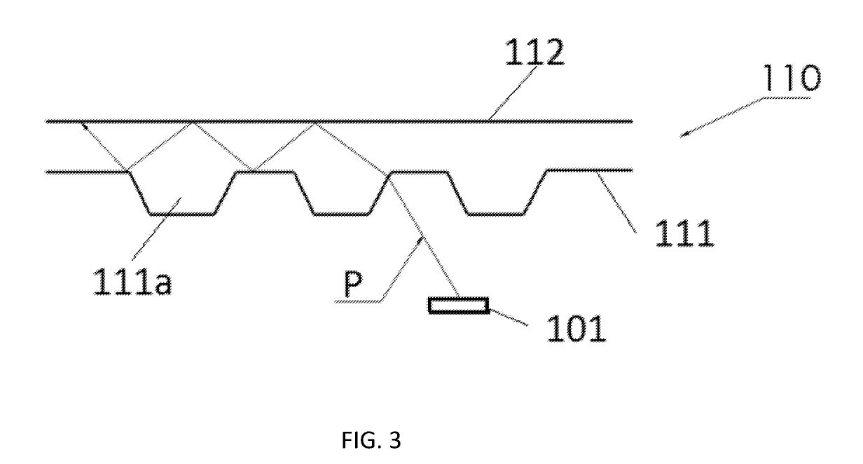

In certain embodiments, the bottom surface of the multi-functional optical unit 100 comprises a plurality of micro structures such as cones, prisms, pyramids, hemispheres, curved pumps, truncated cones, truncated pyramids, and grooves with a cross-section of a triangle, trapezium, trapezoid, square, or rectangular to direct more primary light toward the horizontal direction so that the primary wavelength of light P from the light source 101 can be out of an extraction zone as the light is incident on the top surface 112 of the multi-functional optical unit 100 and can reflect back inside the multi-functional optical unit as shown in FIG. 3 that is a schematic portion of the cross-sectional view of the multi-functional optical unit 100 with structures or micro structures 111a on the bottom surface 111.

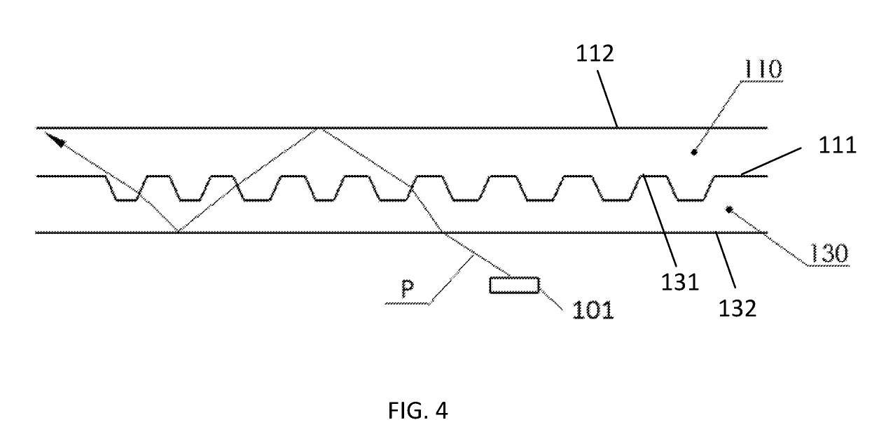

In certain embodiments, the multi-functional optical unit 100 comprises the wavelength conversion layer 110 and a cladding layer 130 placed below the wavelength conversion layer 110. In certain embodiments, the top surface 131 of the cladding layer 130 that interfaces with the bottom surface 111 of the wavelength conversion layer 110 of the multi-functional optical unit 100 comprises at least one of micro structures such as cones, pyramids, hemispheres, curved pumps, truncated cones, truncated pyramids, and grooves with a cross-section of a triangle, trapezium, trapezoid, square, curved, or rectangular shape to direct more primary light toward the horizontal direction so that the primary light can be out of an extraction zone as the light is incident on the top surface 112 of the multi-functional optical unit 100 or on the bottom surface 132 of the cladding layer 130 and can reflect back into the wavelength conversion layer 110, as shown in FIG. 4 that is a schematic portion of a cross-sectional view of the multi-functional optical unit with structures or micro structures at the interface between the wavelength conversion layer 110 and the bottom cladding layer 130. The wavelength conversion layer 110 contains at least the primary fillers afore-described. In operation, the light P emitted from the light source 101 refracts upward as it enters the bottom cladding layer 130 but it bends sideward as it enters the wavelength conversion layer 110 through a side of structure at the interface between these two layers 110 and 130. The light P is then incident on the surface 112 at an angle larger than a critical angle (outside extraction cone angle) and reflects downward back inside the wavelength conversion layer 110. In certain embodiments, the bottom cladding layer 130 is a transparent layer without fillers. In certain embodiments, the bottom cladding layer 130 contains the assisted fillers to further assist guiding the primary light toward x-y-plane direction through scattering. The reflective index of the bottom cladding layer 130 is adapted to be smaller than that of the wavelength conversion layer 110. In certain embodiments, the reflective index of the bottom cladding layer 130 is adapted to be larger than that of the wavelength conversion layer 110.

In certain embodiments, the interface between the wavelength conversion layer 110 and the cladding layer 130 is a smooth surface.

In certain embodiments, the wavelength conversion layer is below the cladding layer such that the wavelength conversion layer 110 now becomes 130 and the cladding layer 130 now becomes 110 as in FIG. 4.

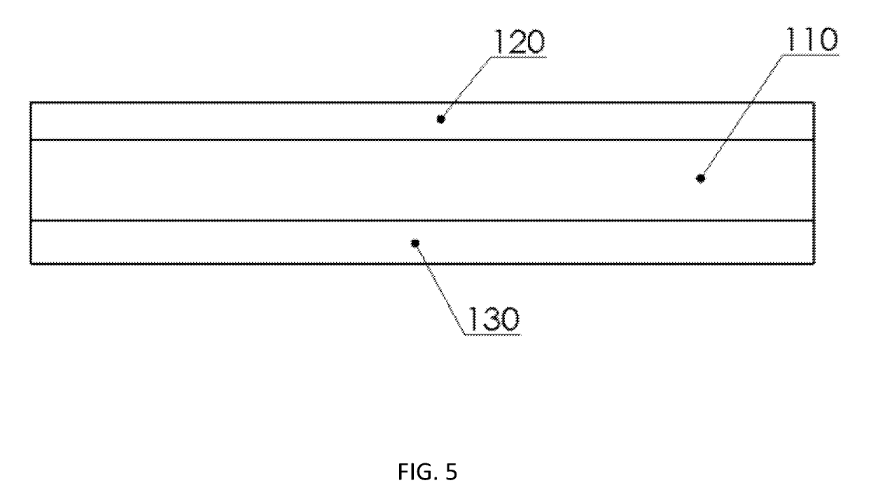

In certain embodiments, the multi-functional optical unit is a multi-layered structure that comprises at least one carrier/cladding layer on the bottom surface or on the top surface of the wavelength conversion layer and the wavelength conversion layer disclosed above. FIG. 5 is a schematic cross-section view of the multi-functional optical unit according to one embodiment of the invention, which is cut by a plane parallel to the vertical axis z. The multi-layered structure of the multi-functional optical unit includes the afore-described wavelength conversion layer 110 that is sandwiched between a top carrier/cladding layer 120 and a bottom carrier/cladding layer 130. In certain embodiments, the carrier/cladding layer 120 can be of glass, polymers, PMMA, polystyrene, polycarbonate, or any optical transparent materials. In certain embodiments, the cladding layers are transparent layers without fillers. In certain embodiments, at least one of the carrier/cladding layers contains the assisted fillers as described above.

In certain embodiments, the wavelength conversion layer of the multi-layered multi-functional optical unit is completely embedded by outer layers: top, bottom, and sides to prevent moisture to penetrate to the wavelength conversion materials.

In certain embodiments, the bottom cladding layer is thick enough so that the multi-functional optical unit can have supporting function and materials such as glass, polymers, PMMA, polystyrene, polycarbonate, or any optical transparent materials can be used to make the bottom cladding layer instead of special moisture barrier materials to protect moisture sensitive wavelength conversion materials such as quantum dot materials.

In certain embodiments, the top and/or bottom cladding layer can have a thickness of up to 2 mm, depending on material being used, to provide supporting function and/or vapor and moisture barrier function.

In certain embodiments, the multi-layered structure of the multi-functional optical unit has a liquid crystal layer residing between the wavelength conversion layer and the top cladding layer, the liquid crystal layer containing liquid crystal material that is arranged in a twisted nematic phase.

In certain embodiments, the multi-functional optical unit comprises a top surface and a bottom surface, and a plurality of microstructures formed on the top surface and/or the bottom surface.

In certain embodiments, the plurality of microstructures includes, but is not limited to, grooves, protrusions, facets, surface or volume holograms, gratings, etc. In certain embodiments, the plurality of microstructures is arranged randomly on the top surface and/or the bottom surface. However, in other embodiments, the plurality of microstructures is arranged on the top surface and/or the bottom surface to form a regular or an irregular pattern. In certain embodiments, the plurality of microstructures has a size in a range of about 0.1 μm to about 3 mm. In certain embodiments, the density of the plurality of microstructures is in a range of about 1000000/mm² to 1/mm².

In certain embodiments, the plurality of microstructures has a size such that an individual microstructure is not resolved by a normal human eye without the aid of magnification. In certain embodiments, each of the plurality of microstructures has a size in a range of about 0.1 μm to 1000 μm. For example, in embodiments where some of the plurality of microstructures include grooves, a depth (or height) of grooves is in a range of about 1 μm to about 10 μm, of about 5 μm to 20 μm, of about 10 μm to 30 μm, of about 30 μm to about 50 μm, of about 40 μm to about 75 μm, of about 50 μm to 80 μm, of about 75 μm to 100 μm, or of about 500 μm, or values therebetween.

As another example, in embodiments where some of the plurality of microstructures include facets, a height of the facets is in a range between about 1 μm and about 10 μm, between about 5 μm and about 20 μm, between about 10 μm and about 30 μm, between about 30 μm and about 50 μm, between about 40 μm and about 75 μm, between about 50 μm and about 80 μm, between about 75 μm and about 100 μm and about 500 μm, or values therebetween.

For example, in implementations where some of the plurality of microstructures include gratings, a depth of the gratings and/or the distance between two consecutive gratings can be in the range between about 1 μm and about 10 μm, between about 5 μm and about 20 μm, between about 10 μm and about 30 μm, between about 30 μm and about 50 μm, between about 40 μm and about 75 μm, between about 50 μm and about 80 μm, between about 75 μm and about 100 μm and about 500 μm, or values therebetween.

In certain embodiments, the multi-functional optical unit comprises the wavelength conversion layer and a cladding layer, where the wavelength conversion layer can be formed on the bottom surface of the cladding layer.

In certain embodiments, a reflective index of the cladding layer is adapted to be larger than that of the wavelength conversion layer. In certain embodiments, the reflective index of the cladding layer is adapted to be smaller than that of the wavelength conversion layer.

In certain embodiments, the multi-functional optical unit is fabricated by providing a mold with a desired structure; blending the wavelength conversion materials, the light trapping-guiding material, the light mixing material, and the matrix material at a predetermined proportion to for a mixture; and feeding the mixture into the mold by a compression molding method, an injection molding method, or a transfer molding method.

In certain embodiments, the multi-functional optical unit is fabricated by providing the cladding layer; blending the wavelength conversion materials, the light trapping-guiding material, the light mixing material, and the matrix material at a predetermined proportion to form a mixture; coating the mixture on a surface of the cladding layer; and curing the coated mixture at a predetermined temperature or curing light energy to form the multi-functional optical unit on the cladding layer.

In certain embodiments, the PCB 102 covers entire bottom area of the LCD system 10 and has a top surface with highly reflective coating layer to replace the reflective sheet 103. The reflective coating layer contains white scattering fillers of barium sulfate or metal oxide such as, but not limited to, titanium dioxide (TiO₂), aluminum oxide (Al₂O₃), zinc oxide (ZnO), magnesium oxide, and etc. In certain embodiments, white scattering fillers can be selected to assist thermal radiation so that heat can be dissipated through radiation path.

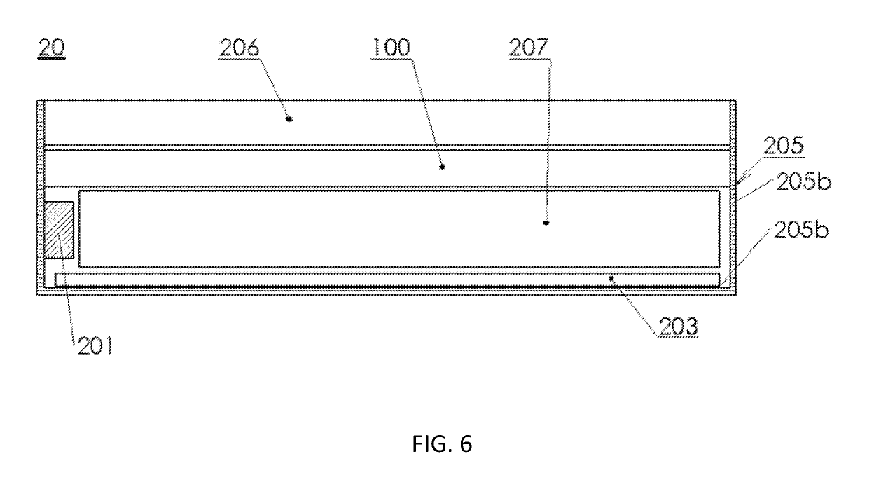

In certain embodiments, the multi-functional optical unit can be also used in other systems such as an edge-lit LCD system where the light sources are placed at the edge of the screen instead at the bottom of screen as in the direct-lit LCD system shown in FIG. 1, and in general panel lighting system. The edge-lit LCD system 20 as shown in FIG. 6 comprises a housing 205 being an open shell with a bottom 205a and side walls 205b, a reflective sheet 203 on top of the bottom surface 205a, the multi-functional optical unit 100, a light guide plate 207 between the reflective sheet 203 and the multi-function optical unit 100, the LCD panel 106 and required components for the LCD panel 206 on top of the multi-functional optical unit 100, and light sources 201 on a side of the light guide plate 207.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments are chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

1. A multi-functional optical unit, comprising:
primary fillers, wherein the primary fillers comprise wavelength conversion materials adapted to function as at least one of mixing light, converting light, and trapping/guiding primary light, wherein the wavelength conversion materials comprise phosphor materials and quantum dot materials that operably and at least partially absorb primary light and/or other appropriate activating light and then emit light of different wavelengths;
assisted fillers, wherein the assisted fillers comprise porous particles and/or non-porous particles that are at least one of metal oxides including titanium dioxide (TiO₂), aluminum oxide (Al₂O₃), zinc oxide (ZnO), and boron oxide, glass, polymers, sapphire, silicon dioxide (SiO₂), polycarbonate, and liquid crystal materials; and
a matrix comprising one of glass, polymers, polymethyl methacrylate (PMMA), polystyrene, polycarbonate, silicone, ceramic composite, thiol-alkene resin, or any optical transparent materials that contain the wavelength conversion materials to form a wavelength conversion layer.

2. The multi-functional optical unit of claim 1, wherein the wavelength conversion materials comprise at least one of green, yellow, green-yellow, orange, and red phosphor particles or quantum dots or dyes that at least partially absorb the primary light of blue, violet, or deep blue from light sources or other appropriate activating light and emit wavelengths of light that are perceived as green, yellow, green-yellow, orange, and red, respectively, by human eyes.

3. The multi-functional optical unit of claim 1, wherein the phosphor materials comprise phosphor particles adapted with a mean free path length per a fixed particle volume amount/percentage in a range around a lowest mean free path length value so that a maximum trapping level is achieved, wherein the phosphor particles have dimensions in a range of about 0.01 μm to 10 μm.

4. The multi-functional optical unit of claim 1, wherein the wavelength conversion materials are distributed uniformly over the single-layered structure, or form a gradient concentration distribution over the single-layered structure.

5. The multi-functional optical unit of claim 1, wherein the assisted fillers are hybrids of fillers of sizes, shapes, and porosities.

6. The multi-functional optical unit of claim 1, wherein the assisted fillers comprise particles with fumed structures, aspherical shapes, and/or elongated shapes such as rods, ellipsoids, tubes, nanorods, nanofibers, nanowires, nanotubes, combinations thereof.

7. The multi-functional optical unit of claim 6, wherein the elongated particles have an aspect ratio in a range of about 1.01 to 1000 and a shorter size in a range of about 4 nm to 4 μm.

8. The multi-functional optical unit of claim 7, wherein the elongated particles are arranged randomly, or arranged with its long dimension forming a small angle arranged with an x-y plane, or with its short dimension forming a small angle with the x-y plane.

9. The multi-functional optical unit of claim 1, wherein the assisted fillers comprise a liquid crystal material operably functioning as light mixing agents, wherein the liquid crystal material is embedded in a matrix containing the wavelength conversion materials.

10. The multi-functional optical unit of claim 1, wherein the assisted fillers comprise spherical particles adapted with a mean free path length per a fixed particle volume amount/percentage in a range around a lowest mean free path length value so that a maximum trapping level is achieved, wherein the spherical particles have dimensions in a range of about 0.01 μm to 10 μm.

11. The multi-functional optical unit of claim 1, wherein the primary fillers and the assisted fillers are mixed in the matrix to form a single-layered structure.

12. The multi-functional optical unit of claim 11, wherein an absolute refractive index difference |Δnₜ| between the matrix and the primary fillers or assisted fillers is in the range of about 0.01 to 2.

13. The multi-functional optical unit of claim 1, wherein one of a top surface and a bottom surface of the multi-functional optical unit comprises a plurality of microstructures being at least one of cones, prisms, pyramids, hemispheres, curved pumps, truncated cones, truncated pyramids, grooves, protrusions, facets, surface or volume holograms, gratings, or combinations thereof, to improve angular color uniformity.

14. The multi-functional optical unit of claim 13, wherein the plurality of microstructures has a size in a range of about 0.1 μm to about 3 mm, and a density in a range of about 1000000/mm² to 1/mm².

15. The multi-functional optical unit of claim 1, further comprising a cladding layer formed on one of a top surface and a bottom surface of the wavelength conversion layer, wherein the cladding layer comprises one of glass, polymers, polymethyl methacrylate (PMMA), polystyrene, polycarbonate, silicone, ceramic composite, or any optical transparent materials.

16. The multi-functional optical unit of claim 15, wherein a reflective index of the cladding layer is different from that of the wavelength conversion layer.

17. The multi-functional optical unit of claim 15, wherein the cladding layer is a transparent layer without fillers.

18. The multi-functional optical unit of claim 15, wherein the cladding layer is formed on the bottom surface of the wavelength conversion layer, wherein a top surface of the cladding layer that interfaces with the bottom surface of the wavelength conversion layer comprises at least one of micro structures including cones, pyramids, hemispheres, curved pumps, truncated cones, truncated pyramids, and grooves to direct more primary light toward the horizontal direction so that the primary light is out of an extraction zone as the light is incident on the top surface of the wavelength conversion layer or on a bottom surface of the cladding layer and reflects back into the wavelength conversion layer.

19. The multi-functional optical unit of claim 15, wherein the cladding layer comprises assisted fillers to assist guiding the primary light toward an x-y-plane direction through scattering.

20. The multi-functional optical unit of claim 15, wherein the interface between the wavelength conversion layer and the cladding layer is a smooth surface.

21. The multi-functional optical unit of claim 1, wherein the wavelength conversion layer is completely embedded by outer layers including top, bottom and side layers to prevent moisture to penetrate to the wavelength conversion materials.

22. The multi-functional optical unit of claim 15, wherein the multi-functional optical unit has a liquid crystal layer residing between the wavelength conversion layer and the top cladding layer, the liquid crystal layer containing liquid crystal material that is arranged in a twisted nematic phase.

23. The multi-functional optical unit of claim 15, further comprising another cladding layer formed on the other of a top surface and a bottom surface of the wavelength conversion layer.

24. The multi-functional optical unit of claim 23, wherein the another cladding layer is a transparent layer with or without the assisted fillers.

25. A panel lighting system, comprising the multi-functional optical unit of claim 1.

26. A display system, comprising the multi-functional optical unit of claim 1.

27. The display system of claim 26, further comprising:
a housing being an open shell having a bottom and side walls;
at least one printed circuit board (PCB) placed on the bottom of the housing;
at least one light source placed on the at least one PCB, wherein at least one light source is adapted to emit primary light;
a reflective sheet covering the at least one PCB and the inner side surface of the housing, wherein the reflective sheet has holes defined corresponding to locations of the at least one light source to expose the at least one light source; and
a liquid crystal display (LCD) panel positioned above the multi-functional optical unit
wherein the multi-functional optical unit is separated from the at least one light source by an air gap, wherein the multi-functional optical unit comprises a single-layered structure or multi-layered structure.

28. The display system of claim 27, wherein the at least one light source comprises light emitting diode (LED) emitters, laser diode (LD) emitters, quantum dot LED (DQLED) emitters, or organic LED (OLED) emitters.

29. The display system of claim 26, further comprising:
a housing being an open shell having a bottom and side walls;
at least one printed circuit board (PCB) placed on the side walls of the housing;
at least one light source placed on the at least one PCB, wherein at least one light source is adapted to emit primary light;
a reflective sheet covering the bottom surface of the housing;
a light guide plate positioned between the reflective sheet and the multi-function optical unit; and
a liquid crystal display (LCD) panel positioned above the multi-functional optical unit, wherein the multi-functional optical unit comprises a single-layered structure or multi-layered structure.

30. The display system of claim 15, the cladding layer has a thickness between 0.02 mm and 2 mm.

31. The display system of claim 1, wherein the wavelength conversion materials further comprise dye materials.
